(19) United States
(12) Patent Application Publication
(10) Pub. No.: US 2023/0166152 A1
(43) Pub. Date: Jun. 1, 2023

(54) LEG AND HIP EXERCISE DEVICE

(71) Applicant: Eun Bee KIM, Chuncheonsi (KR)

(72) Inventor: Eun Bee KIM, Chuncheonsi (KR)

(73) Assignee: Eun Bee KIM, Chuncheonsi (KR)

(21) Appl. No.: 18/070,717

(22) Filed: Nov. 29, 2022

Related U.S. Application Data
(63) Continuation of application No. 16/275,341, filed on Feb. 14, 2019, now abandoned.

(30) Foreign Application Priority Data
Nov. 15, 2020 (KR) 10-2020-0152414
Nov. 17, 2020 (KR) 10-2020-0153238
Mar. 4, 2021 (KR) 10-2021-0035113
Nov. 29, 2021 (KR) 10-2020-0163490
Nov. 29, 2021 (KR) 10-2020-0170941
Dec. 19, 2021 (KR) 10-2021-0002955

(51) Int. Cl. A63B 22/00; A63B 21/055; A63B 21/062; A63B 21/00; A63B 22/06; A63B 23/04; A63B 21/22; B62M 1/36; B62M 1/24

(52) U.S. Cl. CPC A63B 22/0023; A63B 21/0552; A63B 21/0628; A63B 21/4034; A63B 21/4035; A63B 21/4039; A63B 22/0046; A63B 22/0605; A63B 23/0476; A63B 21/22; B62M 1/36; B62M 1/24

(57) ABSTRACT

The present invention relates to an exercise method and an exercise device for performing an exercise suitable for thigh and hip muscles like fitness equipment or an exercise bicycle, and more particularly, to an exercise method and an exercise device for strengthening thigh and hip muscles by performing a movement of lowering legs and then moving the legs backward or putting the legs together or apart from a position of pulling the legs toward a chest of the user with an arm disposed between the legs in a sitting or lying position of the user. In addition, the present invention relates to a leg exercise device including a trajectory measuring device of generating motion range information of the exercise device and making the motion range information as data through a motion range measurement sensor attached to a knee and a hip joint of the user seated on the exercise device, smart device and an application of the smart device.

### TECHNICAL FIELD

The present invention relates to an exercise method and an exercise device for performing an exercise suitable for thigh and hip muscles such as fitness equipment and an exercise bicycle, and more particularly to an exercise method and an exercise device for strengthening thigh and hip muscles by performing a movement of lowering legs and then moving the legs backward or putting the legs together or apart from a position of pulling the legs toward a chest of the user with an arm disposed between the legs in a sitting or lying position of the user.

### BACKGROUND ART

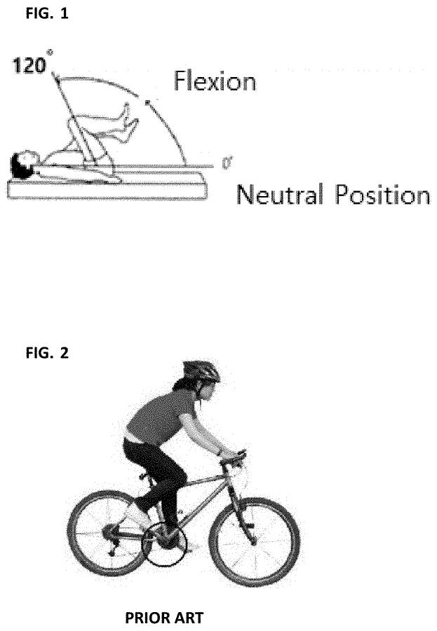

In general, as illustrated in FIG. 1, an exercise for strengthening thigh and hip muscles is performed by pulling legs toward a chest and compressing the legs to the outside by using a pelvis as an axis. However, since a typical exercise method and an exercise device directly transmit a load to an ankle and a knee, ankle and knee joints may be damaged, and a person having weak ankle and knee joints may not perform the exercise method.

In addition, a typical bicycle that is generally used by a knee patient has been developed to go faster more distance with a less force. Thus, as illustrated in FIG. 2, since the bicycle has a pivot axis disposed around an ankle, an exercise is concentrated on lower legs and gives a small effect on upper legs and a hip joint.

### DISCLOSURE OF THE INVENTION

### Technical Problem

As illustrated in FIG. 2, a typical fixed-type bicycle that is generally used by a user who has a weak knee has an insignificant effect of strengthening a hip joint because a motion range of the hip joint is restricted, and an axis of a movement is fixed (an exercise range of about 10 to 20). As illustrated in FIG. 1, a general motion range of the hip joint of a human is about 120°. Thus, the invention of this inventor expands the motion range such that a pivot axis of an exercise device is disposed parallel to a position of a hip joint of a body of a user, and the user performs an exercise of lowering thighs and moving the thighs backward from a start position of pulling the thighs to a chest of the user. However, the exercise device according to the above-described invention shows a few problems.

The exercise device according to the invention has inconvenience in that the user is necessary to change a seat position during exercises when a single arm and a single pivot part are provided so that a seat does not disturb rotation of the arm, and a pivot axis of the arm corresponds to a hip joint. The exercise device, in which the pivot axis and the hip joint are disposed parallel to perform a movement of lowering legs and moving the legs backward from a start position in which the user sits on the seat, places the legs on one end of the arm, and pulls the legs toward the chest of the user, causes discomfort because a length of the arm of the exercise device contacting the body is changed according to a rotation angle of the hip joint or the knee joint. For example, a distance from the pivot axis to the pedal decreases when the legs are raised, and the distance increases when the legs are lowered. Also, knees are over-bent or over-extended to generate side effects.

In case of an axis conversion device of the exercise device according to the prior invention, when a roller connected to a resistance body is hinged from x-axis parallel to the ground to a y-axis perpendicular to the ground, the roller is easily worn because a wire is not fixed to the roller, and thus the wire hits the roller.

### Technical Solution

In order to solve the problem, this inventor expand an exercise range suitable for a motion range of knee joints and the hip joint and increase the exercise effect to be used for exercises.

Specifically, the inventor expands a motion range of the hip joint and the knees by arranging an arm pivot axis of the prior exercise device in parallel to the hip joint in a corresponding manner in order to use the bicycle for exercises.

Also, as a foot plate or a foot pad of the exercise device connected to a weight is positioned on a thigh of an exercising leg, and a movement of raising the exercising leg toward a chest and rotating the leg backward in a sitting or lying position of the user is performed, a force transmitted to the knee and the ankle decreases.

The exercise device according to the invention has inconvenience in that the user is necessary to change a seat position during exercises when a single arm and a single pivot part are provided so that a seat does not disturb rotation of the arm, and a pivot axis of the arm corresponds to a hip joint.

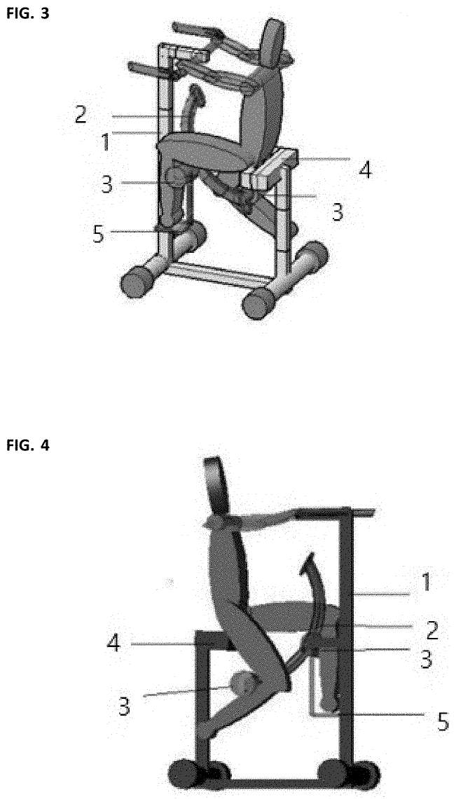

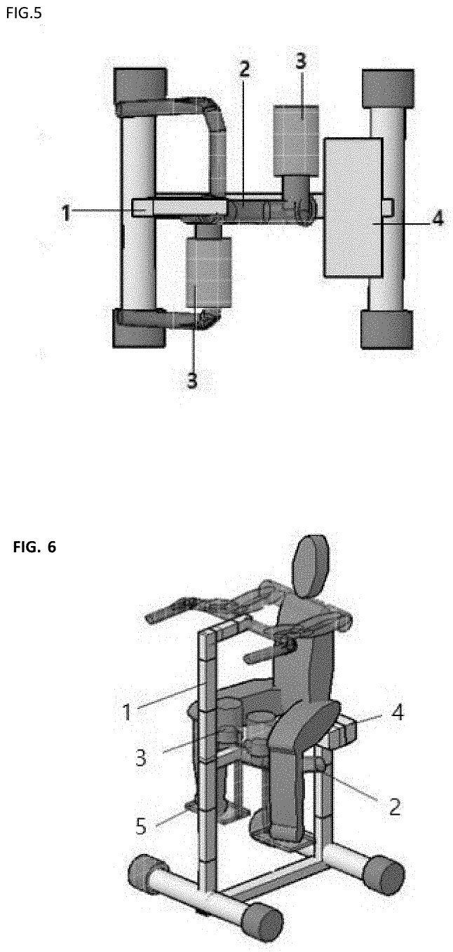

In order to solve the problem, an exercise device according to the present invention is configured such that as an arm slides within a guiding range of a guiding rail 2, and the guiding rail 2 is disposed between both legs of a user when viewed on a plan view, a seat 4 and the arm are not overlapped with each other although the user does not change a position of the seat 4, and two arm pivot parts are not provided to both sides (KR 20-2020-0001877). Additionally, in case of an axis conversion device, when a roller connected to a resistance body is hinged from x-axis parallel to the ground to a y-axis perpendicular to the ground, the roller is easily worn because a wire is not fixed to the roller, and thus the wire hits the roller, the exercise device according to the present invention is configured to move on an x-axis parallel to the ground and rotate on a y-axis perpendicular to the ground by converting the guiding rail in a direction of a X-pivot axis parallel to the ground (FIGS. 3, 4, and 5), in a direction of a y-pivot axis perpendicular to the ground (FIGS. 6, 7, and 8).

### Advantageous Effects

Hereinafter, advantageous effects of the present invention will be described.

The present invention expands a motion range of the hip joint and the knees by arranging an arm pivot axis of the exercise device in parallel to the hip joint in a corresponding manner in order to use the bicycle for exercises.

Also, as a foot plate or a foot pad of the exercise device connected to a weight is positioned on a thigh of an exercising leg, and a movement of raising the exercising leg toward a chest and rotating the leg backward in a sitting or lying position of the user is performed, a force transmitted to the knee and the ankle decreases.

The exercise device according to the invention has convenience in that the user is not necessary to change a seat position during exercises and a seat does not disturb rotation of the arm, and a pivot axis of the arm corresponds to a hip joint. In addition, in case of the axis conversion, to a resistance body hinged from x-axis parallel to the ground to a y-axis perpendicular to the ground, is not easily worn.

The exercise device according to the present invention may simply strengthen the thigh and hip muscles instead of changing the position of the seat by the user or providing two arm pivot parts to both the sides (KR20-2020-0001877).

As a result, the user who have the weak knee and ankle joints or the user who wants to strengthen the thigh and hip muscles without strain of the joints may perform the thigh and hip muscle strengthening exercise by using the exercise method and the exercise device to strength the muscles, ultimately reduce the risk of disease such as diabetes, prevent obesity, and promote health after the middle age. Also, the present invention helps to aesthetically shape the body and athletes to improve the sports ability without strain of the knee and ankle joints.

### BEST MODE FOR CARRYING OUT THE INVENTION

Embodiments of the present invention provide an exercise device that is a bicycle, an indoor bicycle, or fitness equipment, the exercise device include: a frame 1; a seat 4 connected to the frame 1 and allowing a user to have a sitting or lying position; a guiding rail 2 connected to the frame 1; a slide arm 3 slidingly moving with a guiding range of the guiding rail 2; and a leg pad pivotably connected to one end of the slide arm 3 and disposed below legs of the user or disposed to contact a rear surface of the legs of the user.

Also, as the slide arm 3 and the guiding rail 2 are provided so that the slide arm 3 moves along the guiding rail 2 to allow the slide arm 3 to rotate about a pivot axis disposed in a hip joint of the user, the pivot axis of the slide arm 3 rotating along the guiding rail 2 may be disposed corresponding to the hip joint of the user, and as the guiding rail 2 is disposed between both legs of the user when viewed on a plan view as illustrated in FIG. 5, the user may perform a movement in which the user sitting or lying on the seat 4 puts both the legs on the leg pads and alternately lowers the legs and moves the legs backward from a start position in which the legs are pulled toward the user's chest.

### MODE FOR CARRYING OUT THE INVENTION

Hereinafter, detailed descriptions related to well-known functions or configurations will be ruled out in order not to unnecessarily obscure subject matters of the present invention. Since the present invention may, however, be embodied in different forms and various modifications and variations can be made in the present invention, specific embodiments will be described in detail with reference to the accompanying drawings. However, this does not limit the present invention within the specific embodiments and it should be understood that the present invention covers all the modifications, equivalents, and replacements within the idea and technical scope of the present invention. In the following description, the technical terms are used only for explaining a specific example (or embodiment) while not limiting the present disclosure. In the present invention, the meaning of ‘include’ or ‘comprise’ specifies a property, a fixed number, a step, an operation, an element, a component, or a combination thereof but does not exclude other properties, fixed numbers, steps, operations, elements, components, combinations thereof.

Hereinafter, an embodiment of a quads and gluteus exercise of the present invention to achieve the above-described objects will be described in detail with reference to the accompanying drawings.

In order to resolve the problem of the technical object, as illustrated in FIGS. 3 to 8 (KR 20-2020-0001877), an exercise device of the present invention, which performs an exercise suitable for a quads and gluteus exercise, may include: a frame 1; a seat 4 connected to the frame 1 and allowing a user to have a sitting or lying position; a guiding rail 2 connected to the frame 1; a slide arm 3 slidingly moving with a guiding range of the guiding rail 2; and a leg pad pivotably connected to one end of the slide arm 3 and disposed below legs of the user or disposed to contact a rear surface of the legs of the user.

Also, as the slide arm 3 and the guiding rail 2 are provided so that the slide arm 3 moves along the guiding rail 2 to allow the slide arm 3 to rotate about a pivot axis disposed in a hip joint of the user, the pivot axis of the slide arm 3 rotating along the guiding rail 2 may be disposed corresponding to the hip joint of the user, and as the guiding rail 2 is disposed between both legs of the user when viewed on a plan view as illustrated in FIG. 5, the user may perform a movement in which the user sitting or lying on the seat 4 puts both the legs on the leg pads and alternately lowers the legs and moves the legs backward from a start position in which the legs are pulled toward the user's chest.

Preferably, the leg pad is necessary to be disposed on a rear surface of a thigh of the user to protect knees and ankle joints of the user. Also, as illustrated in FIGS. 3, 4, 6, and 7, a foot plate or a pedal may be connected to one end of the leg pad.

In addition, preferably, as illustrated in FIG. 8, the exercise device may be configured to adjust suitably for a portion of a user's body that the user wants to exercise as the guiding rail 2 connected to the frame 1 includes an axis conversion part that converts the guiding rail in a direction of a X-pivot axis parallel to the ground (FIGS. 3, 4, and 5), in a direction of a y-pivot axis perpendicular to the ground (FIGS. 6, 7, and 8), and in a diagonal direction when an angle to the ground is 45°.

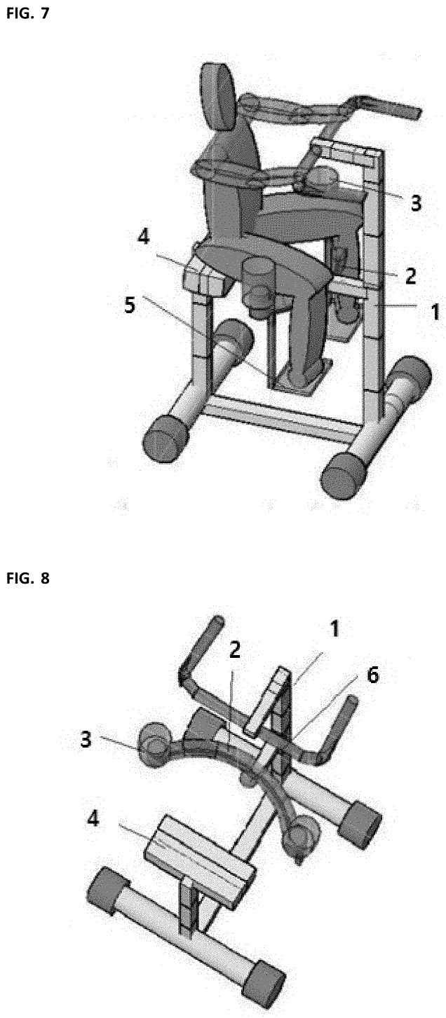

The guiding rail 2 may be disposed perpendicularly to the frame 1 as illustrated in FIGS. 3, 4, and 5 or pivotably provided horizontally to the frame 1 as illustrated in FIGS. 6, 7, and 8, and the axis conversion part may include a fixing unit 6 for fixing the guiding rail 2 to the frame 1. Thus, the user may selectively perform a rotation movement of selectively lowering the legs and moving the legs backward from the start position in which the legs are pulled toward the user's chest, a movement of spreading both the legs apart and then putting the legs together as illustrated in FIG. 6, or a movement of spreading the legs from the start position of putting the legs together as illustrated in FIG. 7.

Preferably, the exercise device of the present invention may include a resistive force generator for generating a resistive force against pivoting of the slide arm 3. The resistive force generator may use a method of using a physical friction such as a tension of a belt and a magnetic drum and include a fluid resistor or a block box connected with a pneumatic pressure, a circular plate, and a wire.

### INDUSTRIAL APPLICABILITY

The exercise device according to the present invention may be used for muscle strengthening equipment, an indoor exercise device, a bicycle, an indoor bicycle, a complex exercise device, a band exercise device, and an exercise device gear.

1. (canceled)

2. (canceled)

3. (canceled)

4. An exercise device for exercising legs and hips, comprising:
a frame;
a seat connected to the frame and configured to allow a user to have a sitting or lying position;
a guiding rail connected to the frame;
a slide arm configured to slide in a guide range of the guiding rail; and
a leg pad pivotably connected to one end of the slide arm and disposed below a leg of a user or disposed to contact a rear surface of the leg of the user,
wherein the slide arm and the guiding rail are provided so that the slide arm rotates about the guiding rail, and
as the guiding rail is disposed between both legs of the user when viewed on a plan view, not to require the user to seat on the seat part at a different position or two guide rails to be provided on both sides, and the user is able to performs a movement of lowering the legs and moving the legs backward by using a hip joint of the user as an axis from a start position in which the user sits or lies on the seat, places the legs on the leg pad, and pulls the legs toward a chest of the user,
wherein the guiding rail connected to the frame comprises an axis conversion part configured to convert a pivot-axis between an x-pivot axis direction parallel to the ground and a y-pivot axis direction perpendicular to the ground to adjust the pivot-axis suitable for a portion of a user's body that the user wants to exercise,
wherein the guiding rail is rotatable perpendicularly or horizontally to the frame, and the axis conversion part comprises a guiding rail fixing device configured to fix the guiding rail to the frame,
wherein, when the guide rail horizontally rotates and is fixed to the frame, the user is able to perform a movement of closing legs from a starting position where the user opens both legs or a movement of opening the legs from a starting position where the user closes both legs.

5. An exercise device for exercising legs and hips, comprising:
a frame;
a seat connected to the frame and configured to allow a user to have a sitting or lying position;
a guiding rail connected to the frame;
a slide arm configured to slide in a guide range of the guiding rail; and
a leg pad pivotably connected to one end of the slide arm and disposed below a leg of a user or disposed to contact a rear surface of the leg of the user,
wherein the slide arm and the guiding rail are provided so that the slide arm rotates about the guiding rail, and
the guide rail is fixed to the frame horizontally to the ground to enable the user to perform a movement of closing legs from a starting position where the user opens both legs or a movement of opening the legs from a starting position where the user closes both legs.

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)
